(19) United States
(12) Patent Application Publication
(10) Pub. No.: US 2010/0277613 A1
(43) Pub. Date: Nov. 4, 2010

(54) IMAGE RECORDING DEVICE AND IMAGE REPRODUCTION DEVICE

(76) Inventors: Yukinaga Seki, Kyoto (JP); Yuki Kobayashi, Osaka (JP); Takuma Chiba, Osaka (JP); Kenjiro Tsuda, Osaka (JP); Hiroaki Shimazaki, Osaka (JP); Tatsuro Juri, Osaka (JP); Katsuo Saigo, Hyogo (JP); Takashi Masuno, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/810,345

(22) PCT Filed: Dec. 26, 2008
(86) PCT No.: PCT/JP2008/004001

§ 371 Date: Jun. 24, 2010

(30) Foreign Application Priority Data
Dec. 28, 2007 (JP) 2007-339634

(51) Int. Cl. H04N 5/76

(52) U.S. Cl. 348/231.2; 348/E05.031

(57) ABSTRACT

An image recording device (100), which can suppress, without causing significant image degradation, image transfer speed from an imaging device, coding speed, and image recording speed that are necessary for high-speed image capturing, includes: an image signal processing unit (102) which sequentially reads, at a frame rate for high-speed image capturing, images generated through image capturing by an imaging unit (101), and outputs, from among the images sequentially read, images read at a frame rate for normal image capturing at high resolution and other images at low resolution; an image coding unit (103) which generates a high resolution coded stream by coding an image sequence made up of the high resolution images outputted by the image signal processing unit (102); a low-resolution image coding unit (104) which generates a low resolution coded stream by coding an image sequence made up of the other low resolution images outputted by the image signal processing unit (102); and a recording processing unit (105) and a recording mechanism unit (106) which record the two streams on a recording medium.

### TECHNICAL FIELD

The present invention relates to an image recording device which records an image, and an image reproduction device which reproduces the recorded image.

### BACKGROUND ART

An image recording device, such as a camcorder which includes an imaging device such as charge coupled devices (CCD), transfers an image generated by the imaging device, codes the image, and records the coded image. Here, for the image recording device to perform high-speed image capturing, it is necessary to increase image transfer speed from the imaging device, coding speed, and image recording speed, and this causes a problem of making the image recording device more expensive.

Thus, an image recording device which has been conventionally proposed performs high-speed image capturing without increasing the image transfer speed from the imaging device, the coding speed, and the image recording speed (For example, see Patent Reference 1).

FIG. 10 is an illustrative diagram for describing an image recording device disclosed in the above Patent Reference 1.

In normal image capturing, as shown in FIG. 10(a), the image recording device transfers a frame 1 and a frame 2 from the imaging device at a predetermined frame rate, codes the frames, and records the coded frame 1 and frame 2.

On the other hand, as shown in FIG. 10(b), in high-speed image capturing, the image recording device changes, by reducing size, respective frames 1 to 4 into small pictures so as to multiplex the small pictures, and records a picture generated by the multiplexing as a normal image. Specifically, in the case of quad-speed image capturing, the image recording device changes each of the frames 1 to 4 captured at high speed into a quarter-sized small picture, multiplexes, into a single picture, the four consecutive small pictures that are quarter in size, and then records the single picture as a normal image. This allows high-speed image capturing without increasing the image transfer speed from the imaging device, and coding speed, and image recording speed.

### Patent Reference 1: Japanese Patent No. 2718409

### DISCLOSURE OF INVENTION

### Problems that Invention is to Solve

However, the image recording device in Patent Reference 1 described above records each frame after reducing size thereof, and this causes a problem of image degradation due to reduced resolution of each frame.

Thus, the present invention is to solve the problem described above, and it is an object of the present invention to provide an image recording device and an image reproduction device which can suppress, without causing significant image degradation, image transfer speed from an imaging device, coding speed, and image recording speed that are necessary for high-speed image capturing.

### Means to Solve the Problems

To achieve the object described above, an image recording device according to an aspect of the present invention is an image recording device which records an image on a recording medium, and the image recording device includes: an image processing unit which sequentially reads, at a second frame rate, images generated by an imaging unit, and outputs, from among the images sequentially read, images read at a first frame rate at first resolution and other images at second resolution, the first frame rate being lower than the second frame rate, and the second resolution being lower than the first resolution; a coding unit which generates a first coded stream by coding an image sequence made up of the images having the first resolution, and generates a second coded stream by coding an image sequence made up of the other images having the second resolution, the images and the other images being outputted by the image processing unit; and a recording unit which records, on the recording medium, the first and the second coded streams generated by the coding unit. For example, the image processing unit generates the other images having the second resolution by reading only pixels that constitute a part of pixels making up the image generated by the imaging unit.

With this, in high-speed image capturing, not all the images read at the second frame rate (high frame rate) are recorded at the first resolution (high resolution), but part of the images (other images) are read at the second resolution (low resolution) lower than the first resolution, so as to be coded and recorded as the second coded stream; thus it is possible to suppress the image transfer speed from the imaging device (imaging unit), the coding speed, and the image recording speed. That is, it is possible to reduce processing load. Furthermore, in high-speed image capturing, images read at the first frame rate (for example, at a low frame rate for normal image capturing), among the images read at the second frame rate (high frame rate), are read at the first resolution (high resolution), so as to be coded and recorded as the first coded stream; thus, the image reproduction device which reads and reproduces the recorded coded stream can reproduce each image (for example, frame) without causing significant image degradation as compared to a conventional example where all the images are recorded at low resolution.

In addition, when reading the other images while sequentially reading two images at the first frame rate, the image processing unit may read pixels each located at a spatial position that differs from one image to another among the other images.

With this, the image reproduction device which reads and reproduces the coded stream can reciprocally interpolate pixels between the other decoded images and can easily converts the other images to high resolution, thus allowing preventing image degradation more reliably.

In addition, to achieve the object described above, an image reproduction device according to another aspect of the present invention is an image reproduction device which reads, from a recording medium, a coded stream of an image sequence made up of images captured at a predetermined frame rate, and reproduces the image sequence, and a first coded stream and a second coded stream are recorded on the recording medium, the first coded stream including first images coded at first resolution, and the second coded stream including second images coded at second resolution lower than the first resolution, and the image reproduction device includes: a read mechanism unit which reads the first and the second coded streams from the recording medium; a decoding unit which decodes the first images from the first coded stream, and decodes the second images from the second coded stream, the first and the second coded streams being read by the read mechanism unit; a resolution conversion unit which converts a resolution of the second images decoded by the decoding unit to the first resolution; and a reproduction unit which causes a display unit provided outside the image reproduction device to display the first and the second images in image capturing order, by processing, as a single video signal, a video signal indicating the first images decoded by the decoding unit and a video signal indicating the second images having the resolution converted to the first resolution.

With this, when performing slow reproduction on the images that are, for example, captured at high speed and included in the first and the second coded streams stored on the recording medium, the images are displayed with the resolution converted to high resolution, from the resolution for the second images (the second resolution) to the first resolution, that is, both the first and the second images are displayed at the first resolution (high resolution) in image capturing order; thus, it is possible to prevent image degradation.

In addition, the resolution conversion unit may further convert a resolution of the first images decoded by the decoding unit to the second resolution, and the reproduction unit may further cause the display unit to display, in the image capturing order, the second images decoded by the decoding unit and the first images having the resolution converted to the second resolution.

With this, both the first and the second images are displayed at the second resolution (low resolution); thus, it is possible to perform, in small pictures, slow reproduction of the images captured at high speed.

In addition, the resolution conversion unit may interpolate a pixel included in one of the first images that are decoded, into a same position as a spatial position of the pixel in one of the second images that are decoded, so as to convert the resolution of the one of the second images to the first resolution. Alternatively, each of the second images coded and included in the second coded stream may include a pixel at a spatial position different from a spatial position of a pixel in another one of the second images, and when assuming that one of the second images that are decoded and sequential in the image capturing order is to be converted, the resolution conversion unit may convert the resolution of the one of the second images to the first resolution by interpolating a pixel included in another one of the second images that is other than the one of the second images that is to be converted, into a same position as the spatial position of the pixel in the one of the second images that is to be converted.

For example, when the images included in the first and the second coded streams stored on the recording medium are images generated by high-speed image capturing, motion between consecutive images is extremely small. Thus, it is possible to easily convert the second images to the first resolution by interpolating a pixel of the first image or another second image that is temporally closest to the second image to be converted, into the same position as the spatial position of the pixel on the second image to be converted.

In addition, the resolution conversion unit may estimate motion between one of the first images that are decoded and one of the second images that are decoded, may compensate the one of the first images with the estimated motion, and may interpolate a pixel included in the one of the first images that is compensated with the estimated motion, into a same position as the spatial position of the pixel in the one of the second images, so as to convert the resolution of the one of the second images to the first resolution. Alternatively, the resolution conversion unit may estimate motion between one of the second images that are decoded and another one of the second images, may compensate the one of the second images with the estimated motion, and may interpolate a pixel included in the one of the second images that is compensated with the estimated motion, into a same position as the spatial position of the pixel in the another one of the second images that is decoded, so as to convert a resolution of the another one of the second images to the first resolution.

With this, even when there is motion between the second image to be converted and the first image or the other second image, the motion is compensated, and the pixel of the first or the other second image compensated with the motion is interpolated into the second image to be converted; thus, it is possible to appropriately convert the second image to high resolution.

In addition, to achieve the object described above, an integrated circuit according to an aspect of the present invention is an integrated circuit for recording an image on a recording medium, and the integrated circuit includes: an image processing unit which sequentially reads, at a second frame rate, images generated by an imaging unit, and outputs, from among the images sequentially read, images read at a first frame rate at first resolution and other images at second resolution, the first frame rate being lower than the second frame rate, and the second resolution being lower than the first resolution; a coding unit which generates a first coded stream by coding an image sequence made up of the images having the first resolution, and generates a second coded stream by coding an image sequence made up of the other images having the second resolution, the images and the other images being outputted by the image processing unit; and a recording unit which causes a recording mechanism unit to record, on the recording medium, the first and the second coded streams generated by the coding unit.

In addition, to achieve the object described above, the integrated circuit according to another aspect of the present invention is an integrated circuit which reads, from a recording medium, a coded stream of an image sequence made up of images captured at a predetermined frame rate, and reproduces the image sequence, and a first coded stream and a second coded stream are recorded on the recording medium, the first coded stream including first images coded at first resolution, and the second coded stream including second images coded at second resolution lower than the first resolution, and the integrated circuit includes: a read processing unit which causes the read mechanism unit to read the first and the second coded streams from the recording medium; a decoding unit which decodes the first images from the first coded stream, and decodes the second images from the second coded stream, the first and the second coded streams being read by the read mechanism unit; a resolution conversion unit which converts a resolution of the second images decoded by the decoding unit to the first resolution; and a reproduction unit which causes a display unit to display the first and the second images in image capturing order, by processing, as a single video signal, a video signal indicating the first images decoded by the decoding unit and a video signal indicating the second images having the resolution converted to the first resolution.

Note that the present invention can be realized not only as an image recording device and an image reproduction device as described above but also as: an image recording method used in the image recording device to record an image; an image reproduction method used in the image reproduction device to reproduce the image; a program causing a computer to execute the recording and the reproduction using these methods; and a recording medium on which the program is recorded. In addition, it goes without saying that the program described above can be distributed via a transmission medium such as the Internet or a recording medium such as a digital versatile disk (DVD).

### Disclosure of Invention

The image recording device and the image reproduction device according to an implementation of the present invention produces an advantageous effect of suppressing image transmission speed from an imaging device, coding speed, and image recording speed without causing significant image degradation in high-speed image capturing.

### BRIEF DESCRIPTION OF DRAWINGS

FIG. 1 is a block diagram showing a configuration of an image recording device according to a first embodiment of the present invention.

FIG. 2 is a diagram for describing an example of conversion to low resolution in the first embodiment.

FIG. 3 is a diagram showing resolution of images recorded in high-speed image capturing in the first embodiment.

FIG. 4 is a flowchart showing an operation of the image recording device in the first embodiment.

FIG. 5 is a block diagram showing a configuration of an image reproduction device according to a second embodiment of the present invention.

FIG. 6 is an illustrative diagram for describing an example of converting an image to high resolution by a resolution conversion unit in the second embodiment.

FIG. 7 is an illustrative diagram for describing an example of converting an image to high resolution by a resolution conversion unit in the second embodiment.

FIG. 8 is a flowchart showing an operation of the image recording device in the second embodiment.

FIG. 9 is a diagram showing an example of an application of the image recording device and the image reproduction device according to an embodiment of the present invention.

FIG. 10 is a diagram showing an example of an image recording method used in a conventional image recording device.

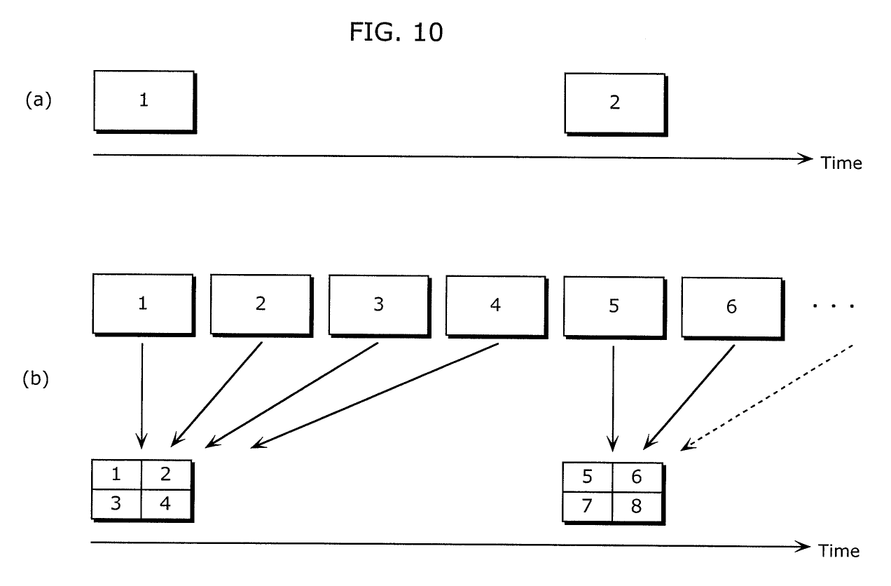

### NUMERICAL REFERENCES

100 Image recording device
101 Imaging unit
102 Image signal processing unit
103 Image coding unit
104 Low-resolution image coding unit
105 Recording processing unit
106 Recording mechanism unit
107 Recording operation unit
200 Image reproduction device
210 Read processing unit
211 Image coding unit
212 Low-resolution image coding unit
213 Resolution conversion unit
214 Reproduction unit
215 Read mechanism unit
216 Reproduction operation unit

### BEST MODE FOR CARRYING OUT THE INVENTION

Hereinafter, embodiments according to the present invention will be described with reference to the drawings.

### First Embodiment

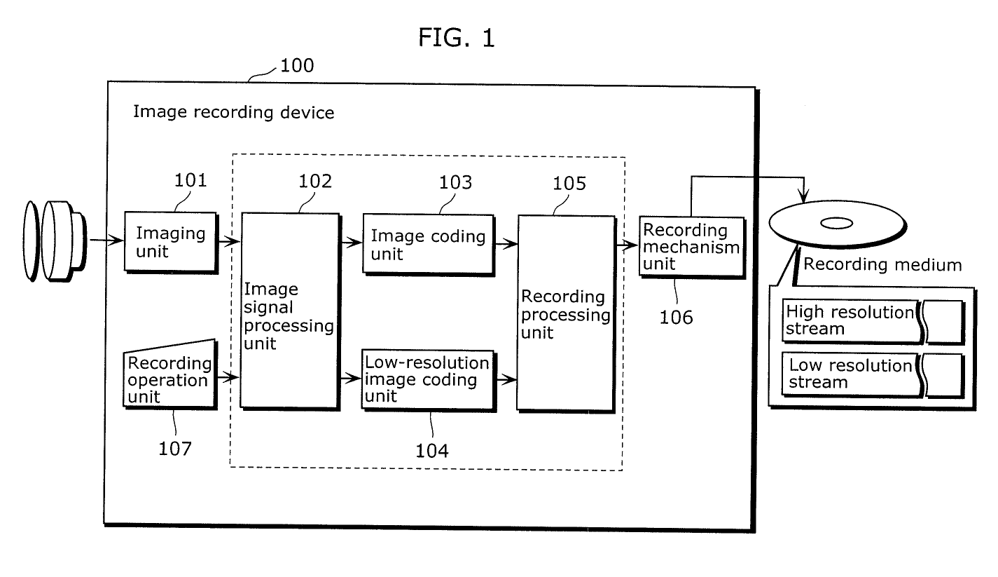

FIG. 1 is a block diagram showing a configuration of an image recording device according to a first embodiment of the present invention. The image recording device 100 according to the present embodiment includes: an imaging unit 101, an image signal processing unit 102, an image coding unit 103, a low-resolution image coding unit 104, a recording processing unit 105, a recording mechanism unit 106, and a recording operation unit 107.

The imaging unit 101 includes an imaging device, for example, charge coupled devices (CCD), and generates images each made up of pixels (hereinafter, referred to as captured images) by obtaining an optical signal that is incident through an optical instrument such as a lens and converting the optical signal into an electric signal, that is, by performing image capturing.

The recording operation unit 107 receives an operation entered by the user. For example, the recording operation unit 107 receives a start or stop command of normal image capturing, or receives a start or stop command of high-speed image capturing.

When the recording operation unit 107 receives the start command of normal image capturing, the image signal processing unit 102 sequentially reads, at a low frame rate (first frame rate), the captured images generated by the imaging unit 101, and outputs all the images that are read to the image coding unit 103. Here, the image signal processing unit 102 outputs the images having high resolution (first resolution) to the image coding unit 103 by reading all the pixels making up the captured images and outputting the pixels to the image coding unit 103.

In addition, when the image signal processing unit 102 receives the start command of high-speed image capturing, the image signal processing unit 102 reads, at a high frame rate (second frame rate), the captured images generated by the imaging unit 101. At this time, from among the images read at the high frame rate, the image signal processing unit 102 outputs, to the image coding unit 103, only images corresponding to the low frame rate as described above, and outputs the other images to the low-resolution image coding unit 104. Here, the image signal processing unit 102 outputs, at high resolution, the images corresponding to the low frame rate to the image coding unit 103, by reading all the pixels making up the captured images and outputting the pixels to the image coding unit 103. In addition, the image signal processing unit 102 generates the other images at low resolution (the second resolution) by reading only a part of all the pixels making up the captured images and outputting the part to the image coding unit 103, and outputs the generated images to the low-resolution image coding unit 104.

Note that the images read from the imaging unit 101 are, for example, field images read by the interlace method or frame images read by the progressive method.

The image coding unit 103 obtains the images sequentially outputted from the image signal processing unit 102, sequentially generates coded data by coding an image sequence made up of the images, and outputs the coded data to the recording processing unit 105. The image coding unit 104, as with the image coding unit 103 described above, obtains the images sequentially outputted from the image signal processing unit 102, sequentially generates coded data by coding an image sequence made up of the images, and outputs the coded data to the recording processing unit 105.

The recording mechanism unit 106 writes the data on a recording medium such as a digital versatile disk (DVD) and a Blu-ray Disc (BD), based on the control performed by the recording processing unit 105.

The recording processing unit 105 sequentially obtains the coded data outputted from the image coding unit 103 and the low-resolution image coding unit 104, and writes the coded data as a stream on the recording medium described above by controlling the recording mechanism unit 106.

Specifically, in normal image capturing, the recording processing unit 105 sequentially obtains the coded data outputted from the image coding unit 103, and writes a high resolution stream made up of the coded data on the recording medium. In addition, in high-speed image capturing, the recording processing unit 105 sequentially obtains the coded data outputted from the image coding unit 103 and writes the high resolution stream made up of the coded data on the recording medium, while at the same time sequentially obtaining the coded data outputted from the low-resolution image coding unit 104 and writing a low resolution stream made up of the coded data on the recording medium.

Such an image recording device 100, in normal image capturing, sequentially reads images at a predetermined resolution, codes the images, and records the coded images on the recording medium. On the other hand, in high-speed image capturing, the image recording device 100 reads, in addition to the images read at time intervals for the normal image capturing, an image which is located between these images and is recorded only in high-speed image capturing. Then, among the images read in the high-speed image capturing, the image recording device 100 codes, as in the normal image capturing, an image that is read at the time intervals for normal image capturing, and records the coded image on the recording medium. In addition, for the images to be recorded only in high-speed image capturing, the image recording device 100 reads the images from the imaging unit 101 at resolution lower than the predetermined resolution by decimating pixels to read, codes the low resolution images, and records the coded images on the recording medium.

Note that part of constituent elements of the image recording device 100, for example, the image signal processing unit 102, the image coding unit 103, the low-resolution image coding unit 104, and the recording processing unit 105 that are enclosed by a dotted line in FIG. 1, may be configured with an integrated circuit.

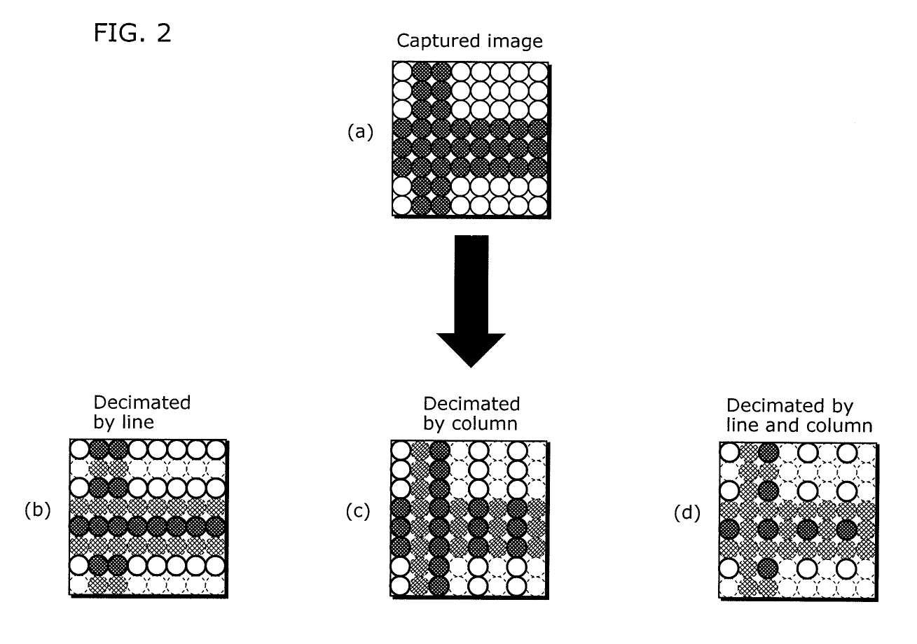

FIG. 2 is a diagram for describing an example of conversion to low resolution.

For example, when reading a captured image generated by the imaging unit 101, the image signal processing unit 102 converts the image to low resolution by decimating pixels to read instead of reading all the pixels included in the captured image. Specifically, the image signal processing unit 102 decimates pixels included in odd or even lines as shown in FIG. 2(b), from all the pixels included in the captured image shown in FIG. 2(a), or decimates pixels included in odd or even columns as shown in FIG. 2(c). Alternatively, the image signal processing unit 102 may decimate pixels included in at least one of the odd or even lines and the odd or even columns as shown in FIG. 2(d).

In other words, the image signal processing unit 102 reads a remaining part of the pixels other than the pixels decimated as described above, from among all the pixels making up the captured image. Specifically, the image signal processing unit 102 reads, in units of lines, only pixels included in odd lines as shown in FIG. 2(b), or reads, in units of columns, only pixels included in odd columns as shown in FIG. 2(c). Alternatively, as shown in FIG. 2(d), the image signal processing unit 102 may specify odd lines and odd columns, respectively, from pixels making up the captured images, and read a pixel at an intersection between each line and each column that are specified.

Note that in FIG. 2, in the image after the decimation, pixels thickly drawn with heavy lines are read pixels, and thinly-drawn pixels are decimated pixels. In addition, by performing decimation other than the decimation shown in FIG. 2, the image may be converted to low resolution, and the method of decimation and the position of the pixels to be decimated may be changed according to each image.

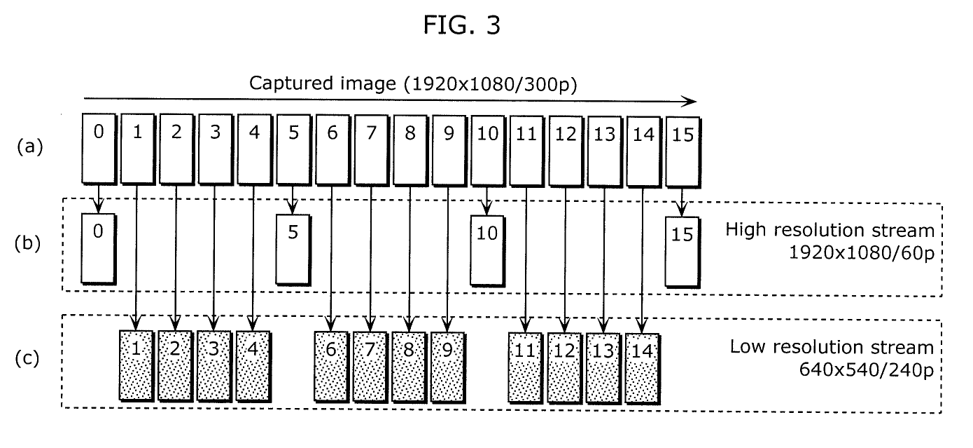

FIG. 3 is a diagram showing resolution of images recorded in high-speed image capturing.

For example, as shown in FIG. 3(a), the imaging unit 101 generates captured images each having resolution of 1920×1080 (pixels), by performing image capturing. Note that numerals in FIG. 3 indicate an order of capturing the respective images. That is, an image i (i is an integer) is an i-th captured image.

The image signal processing unit 102, in high-speed image capturing, reads each image from the imaging unit 101 at a rate of 300 frames per second. At this time, the image signal processing unit 102 reads images having resolution of 1920×1080 from the imaging unit 101 at a rate of 60 frames per second, and outputs the images to the image coding unit 103. At the same time, the image signal processing unit 102 reads images having resolution of 640×540 from the imaging unit 101 at a rate of 240 frames per second, and outputs the images to the low-resolution image coding unit 104. These images having resolution of 640×540 are low resolution images recorded only in high-speed image capturing, and are images from which pixels are decimated and to be horizontally and vertically reduced in size to a sixth of the original images.

Specifically, the image signal processing unit 102 reads an image 0 at high resolution of 1920×1080, and subsequently reads images 1 to 4 at low resolution of 640×540. Furthermore, the image signal processing unit 102 reads an image 5 at high resolution of 1920×1080, and subsequently reads images 6 to 9 at low resolution of 640×540. The image signal processing unit 102 repeats performing this processing. As a result, the image signal processing unit 102 generates and outputs a high resolution stream made up of images 0, 5, 10, and 15, and at the same time generates and outputs a low resolution stream made up of the images 1 to 4, images 6 to 9, and images 11 to 14. These streams are coded by the image coding unit 103 or the low-resolution image coding unit 104, and are recorded on the recording medium by the recording processing unit 105 and the recording mechanism unit 106.

As shown in FIG. 3, in high-speed image capturing, the image transfer speed from the imaging unit 101, coding speed, and image recording speed that are necessary for the high-speed image capturing increase to: 1+4×(⅓)×(½)= 5/3, which is an increase of approximately 66%. On the other hand, when, as conventionally, reading and recording all the images at high resolution of 1920×1080, the image transfer speed from the imaging unit 101, coding speed, and image recording speed that are necessary for the high-speed image capturing increase five-fold as compared to the case of normal image capturing. Thus, the image recording device 100 according to the present embodiment can significantly suppress the image transfer speed from the imaging unit 101, coding speed, and image recording speed.

Generally, the image recording device 100 according to the first embodiment can suppress the image transfer speed from the imaging unit 101, coding speed, and image recording speed that are necessary for the high-speed image capturing, from an N-fold in normal image capturing to 1+(N−1)/M-fold, by decimating pixels such that the images to be recoded only in high-speed image capturing become 1/Mth of the captured images in size and recording the images from which the pixels are decimated.

As described above, by recoding, at low resolution, the images that are to be recorded only in high-speed image capturing, the image recording device 100 according to the first embodiment can suppress the image transfer speed from the imaging unit 101, coding speed, and image recording speed that are necessary for high-speed image capturing. Furthermore, even in high-speed image capturing, the images read at the time intervals for normal image capturing are read at high resolution; thus it is possible to prevent image degradation.

Note that here all the images to be recorded only in high-speed image capturing have been assumed to be recorded at resolution lower than the resolution for reading images at the time intervals for normal image capturing, but part of the images may be read from the imaging unit 101 at the same resolution for reading the images at the time intervals for normal image capturing and may be coded by the image coding unit 103. With this, although the image transfer speed from the imaging unit 101, coding speed, and image recording speed slightly increase, it is possible to perform high-speed image capturing with higher image quality.

In addition, the image coding unit 103 and the low-resolution image coding unit 104 may share all or part of the functions of each other.

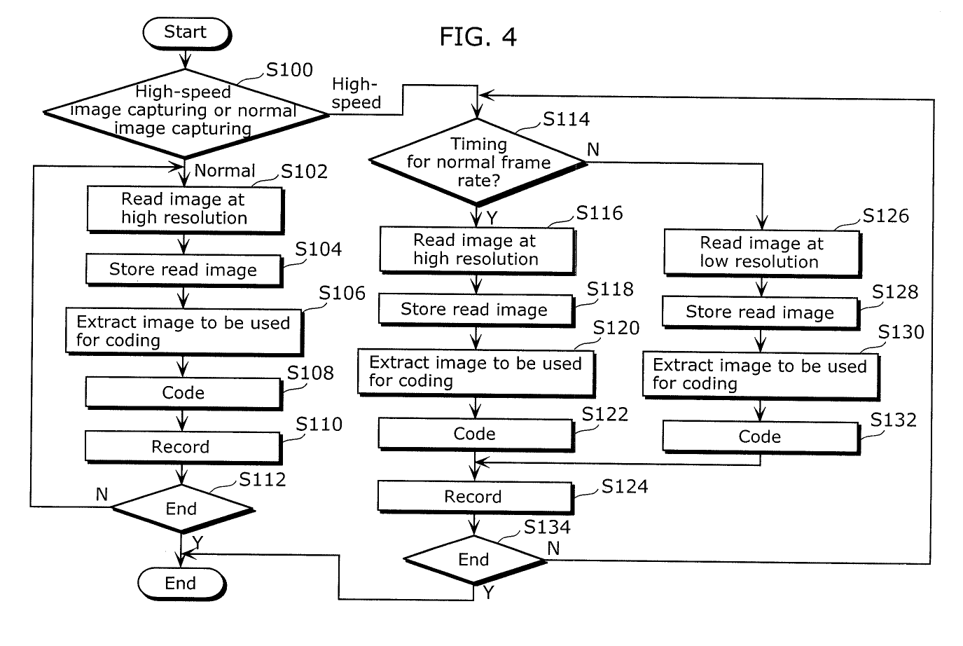

FIG. 4 is a flowchart showing an operation of the image recording device 100 in the present embodiment.

The image recording device 100 determines whether to perform high-speed image capturing or to perform normal image capturing, based on the operation received by the recording operation unit 107 (Step S100). Here, when judging that normal image capturing is to be performed (Normal in Step S100), the image recording device 100 reads an image at high resolution from the imaging unit 101 with timing indicated by the low frame rate (Step S102), and stores the read image into a buffer (for example, a buffer in the image signal processing unit 102) (Step S104). Then, the image recording device 100 extracts, from the buffer, an image to be used for coding (Step S106), codes the image (Step S108), and records coded data generated by the coding on a recording medium (Step S110). Note that in Step S106, if the image to be used for the coding is not accumulated in the buffer, the processing in the steps S106, S108, and S110 are omitted. Furthermore, the image recording device 100 determines whether or not to terminate the normal image capturing, based on the operation received by the recording operation unit 107 (Step S112). The image recording device 100 repeats performing the processing from Step S102 when determining that the normal image capturing is not to be terminated (N in Step S112), and terminates the normal image capturing when determining that the normal image capturing is to be terminated (Y in Step S112).

On the other hand, when, in Step S100, determining that high-speed image capturing is to be performed (High-speed in Step S100), the image recording device 100 further determines whether or not the timing of reading indicated by the high frame rate is the timing of reading indicated by the low frame rate (normal frame rate) (Step S114).

Here, when judging that the timing of reading is the timing of reading indicated by the low frame rate (Y in Step S114), the image recording device 100 reads an image from the imaging unit 101 at high resolution (Step S116) and stores the read image into the buffer (Step S118) in the same manner as described above. Then, the image recording device 100 extracts, from the buffer, an image to be used for coding (Step S120), codes the image (Step S122), and records coded data generated by the coding on the recording medium (Step S124). Note that in Step S120, if the image to be used for the coding is not accumulated in the buffer, the processing in the steps S120, S122, and S124 are omitted. On the other hand, when judging that the timing of reading is not the timing of reading indicated by the low frame rate (N in Step S114), the image recording device 100 reads an image from the imaging unit 101 at low resolution (Step S126) by decimating pixels, and stores the read image into the buffer (Step S128). Then, the image recording device 100 extracts, from the buffer, an image to be used for coding (Step S130), codes the image (Step S132), and records coded data generated by the coding on the recording medium (Step S124). Note that in Step S130, if the image to be used for the coding is not accumulated in the buffer, the processing in the steps S130, S132, and S124 are omitted. Furthermore, the image recording device 100 determines whether or not to terminate the high-speed image capturing, based on the operation received by the recording operation unit 107 (Step S134). The image recording device 100 repeats performing the processing from Step S114 when determining that the high-speed image capturing is not to be terminated (N in Step S134), and terminates the high-speed image capturing when determining that the high-speed image capturing is to be terminated (Y in Step S134).

Note that in the operation of the image recording device 100 shown in FIG. 4, the reading of an image from the imaging unit 101, the coding, and the recording have been performed in synchronization, but they need not be performed in synchronization. In other words, a cycle of reading the image from the imaging unit 101 and storing the image into the buffer and a cycle of extracting and coding one or more images stored in the buffer may be different.

### Second Embodiment

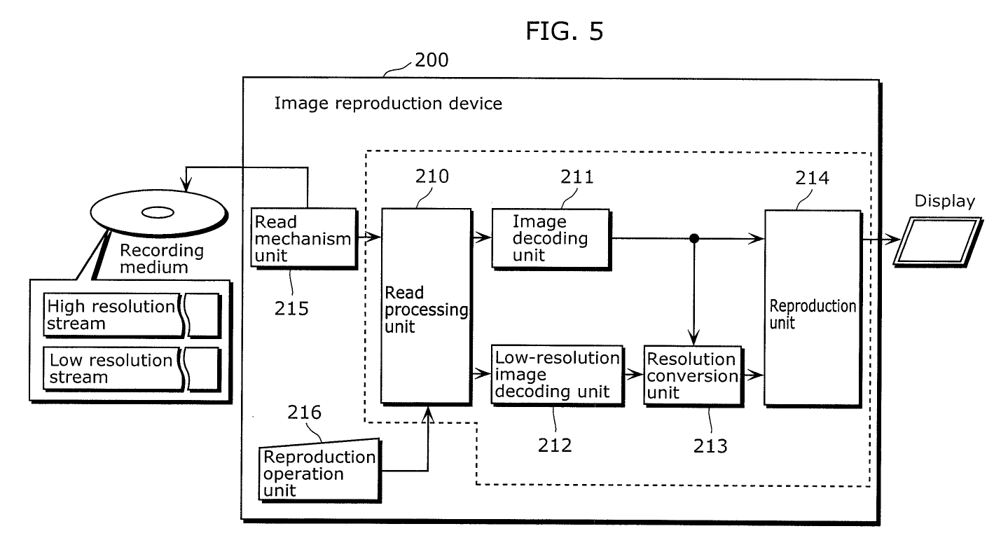

FIG. 5 is a block diagram showing a configuration of an image reproduction device according to a second embodiment of the present invention. An image reproduction device 200 in the present embodiment includes: a read processing unit 210, an image decoding unit 211, a low-resolution image decoding unit 212, a resolution conversion unit 213, a reproduction unit 214, a read mechanism unit 215, and a reproduction operation unit 216.

The reproduction operation unit 216 receives an operation entered by a user. For example, the reproduction operation unit 216 receives a start or stop command of normal reproduction, or receives a start or stop command of slow reproduction.

The read mechanism unit 215 reads, based on the control performed by the read processing unit 210, a stream (at least one of a high resolution stream and a low resolution stream) stored on the recording medium described above, and outputs the stream to the read processing unit 210.

The read processing unit 210 causes the read mechanism unit 215 to execute reading, according to the operation received by the reproduction operation unit 216, so as to obtain the read stream.

Specifically, when the reproduction operation unit 216 receives the start command of the normal reproduction of the high resolution stream recorded by normal image capturing, the read processing unit 210 causes the read mechanism unit 215 to read the high resolution stream. Then, the read processing unit 210 obtains the high resolution stream read by the read mechanism unit 215 and outputs the high resolution stream to the image decoding unit 211.

In addition, when the reproduction operation unit 216 receives the start command of the normal reproduction of the streams (low resolution stream and high resolution stream) recorded by high-speed image capturing, the read processing unit 210 causes the read mechanism unit 215 to read the high resolution image stream. Then, the read processing unit 210 obtains the high resolution stream read by the read mechanism unit 215 and outputs the high resolution stream to the image decoding unit 211.

Furthermore, when the reproduction operation unit 216 receives the start command of the slow reproduction of the streams recorded by high-speed image capturing, the read processing unit 210 causes the read mechanism unit 215 to read all the streams, that is, the low resolution stream and the high resolution stream. Then, the read processing unit 210 obtains the high resolution stream read by the read mechanism unit 215 and outputs the high resolution stream to the image decoding unit 211, and also obtains the low resolution stream read by the read mechanism unit 215 and outputs the low resolution stream to the low-resolution image decoding unit 212.

The image decoding unit 211 sequentially generates and outputs high resolution images by obtaining the high resolution stream from the read processing unit 210 and decoding the high resolution stream.

The image decoding unit 212 sequentially generates and outputs low resolution images by obtaining the low resolution stream from the read processing unit 210 and decoding the low resolution stream.

The resolution conversion unit 213 sequentially obtains low resolution images from the low-resolution image decoding unit 212, and converts the low resolution images to high resolution so as to output the high resolution images to the reproduction unit 214. In other words, the resolution conversion unit 213 obtains, from the image decoding unit 211, high resolution images corresponding to the low resolution images obtained from the low-resolution image decoding unit 212. Then, the resolution conversion unit 213 converts the low resolution images to high resolution, using the high resolution images. Note that the high resolution images corresponding to the low resolution images are high resolution images closest to the low resolution images in image capturing order (display order).

Thus, the resolution conversion unit 213 performs conversion to high resolution such that the resolution of the images outputted from the low-resolution image decoding unit 212 becomes equivalent to the resolution of the images outputted from the image decoding unit 211.

When the high resolution images are outputted only from the image decoding unit 211, the reproduction unit 214 obtains plural high resolution images from among the high resolution images, arranges them in image capturing order (display order), and causes them to be displayed by the display (display unit) provided outside the image reproduction device 200. In addition, when the high resolution images are outputted from the image decoding unit 211 and the resolution conversion unit 213, the reproduction unit 214 obtains the high resolution images, arranges them in image capturing order, and causes them to be displayed by the display outside the image reproduction device 200.

Such an image reproduction device 200 reads, decodes, and reproduces the stream recorded at the low frame rate for normal image capturing, when reproducing the stream recorded by normal image capturing or when reproducing, at normal speed, the stream recorded by high-speed image capturing. In the case of the reproduction at normal speed, the images captured by high-speed image capturing have resolution equivalent to the resolution of the images captured by normal image capturing.

On the other hand, in the case of slow reproduction of the stream recorded by high-speed image capturing, the image reproduction device 200 also reads, in addition to the high resolution stream recorded at the frame rate for normal image capturing, a low resolution stream made up of coded low resolution images that are recorded only in high-speed image capturing. Then, the image reproduction device 200 decodes the low resolution stream, and interpolates a pixel of a high resolution image into a position of a pixel decimated from a low resolution image, to thereby convert the low resolution image to high resolution. Subsequently, the image reproduction device 200 displays, in image capturing order, the images converted to high resolution, and the high resolution images generated by the capturing at normal speed.

Note that part of the constituent elements of the image reproduction device 200, for example, the read processing unit 210, the image decoding unit 211, the low-resolution image decoding unit 212, the resolution conversion unit 213, and the reproduction unit 214 that are enclosed by a dotted line in FIG. 5, may be configured with an integrated circuit.

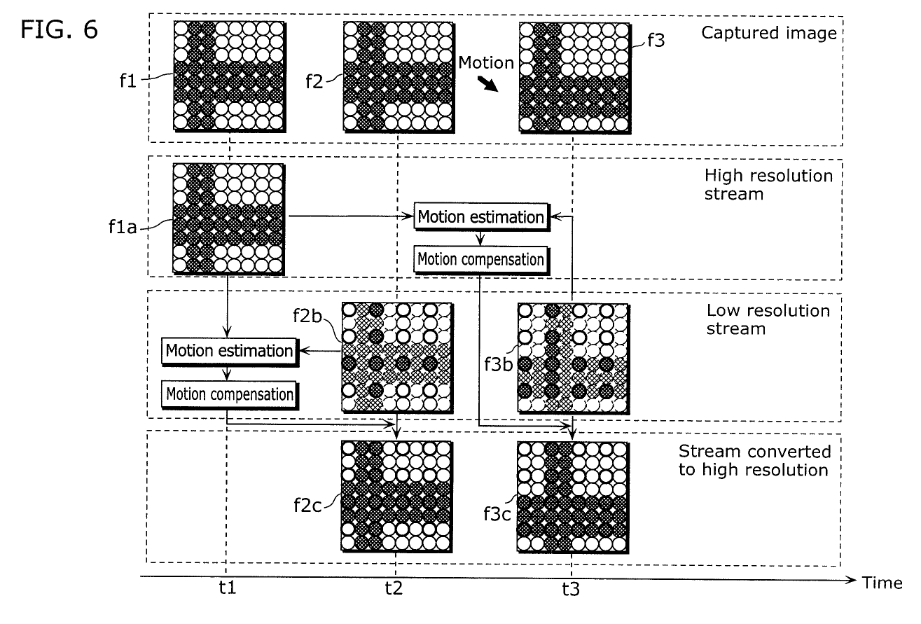

FIG. 6 is an illustrative diagram for describing an example of converting an image to high resolution by the resolution conversion unit 213.

The resolution conversion unit 213, for example, interpolates pixels into a low resolution image, using a high resolution image, to thereby convert the low resolution image to high resolution.

Specifically, as shown in FIG. 6, the imaging unit 101 in the image recording device 100 according to the first embodiment generates captured images f1, f2, and f3 with timing according to the high frame rate. In other words, the captured image f1 is generated at time t1, the captured image f2 is generated at time t2, and the captured image f3 is generated at time t3. Note that there is no motion between the captured images f1 and f2, and there is motion between the captured images f2 and f3.

In the high-speed image capturing performed by the image recording device 100, such captured images f1 to f3 are recorded on the recording medium as a high resolution stream including coded data for displaying a high resolution image f1a and a low resolution stream including coded data for displaying low resolution images f2b and f3b. In other words, the image f1a generated by decoding the high resolution stream is identical to the captured image f1, and the images f2b and f3b generated by decoding the low resolution stream are images obtained by decimating pixels from the captured images f2 and f3, respectively, such that the captured images f2 and f3 are vertically and horizontally reduced to half in size. Note that in each of the images f2b and f3b shown in FIG. 6, pixels thickly drawn with heavy lines are pixels included in the image and recorded on the recording medium, and thinly-drawn pixels are decimated pixels that are not recorded on the recording medium.

The resolution conversion unit 213 uses the high-resolution image f1a when converting the low resolution image f2b to high resolution. Here, as described above, there is no motion between the captured images f1 and f2. In other words, there is no motion between the images f1a and f2b, either. Accordingly, the resolution conversion unit 213 estimates that the size of a motion vector of the image is 0, as a result of estimating the motion between the images f1a and f2b by a method such as block matching. Here, the resolution conversion unit 213 interpolates, per spatial position of each pixel decimated from the image f2b, a pixel which is located at the same spatial position on the image f1a as the spatial position of the pixel decimated from the image f2b, into the spatial position of the decimated pixel on the image f2b. With this, the resolution conversion unit 213 converts the low resolution image f2b into the high-resolution image f2c.

In addition, the resolution conversion unit 213 uses the high resolution image f1a in the same manner as described above, when converting the low resolution image f3b to high resolution. Here, as described above, there is motion between the captured images f2 and f3. In other words, there is also motion between the images f1 and f3b. Accordingly, the resolution conversion unit 213 estimates that the size of the motion vector of the image is other than 0, as a result of estimating the motion between the images f1a and f3b by a method such as block matching. Here, the resolution conversion unit 213 performs motion compensation on the image f1a according to the motion vector. The resolution conversion unit 213 interpolates, per spatial position of each pixel decimated from the image f3b, a pixel located at the same spatial position on the motion-compensated image f1a as the spatial position of the pixel decimated from the image f3b, into the spatial position of the decimated pixel on the image f3b. With this, the resolution conversion unit 213 converts the low resolution image f3b into a high resolution image f3c. By thus performing motion compensation and pixel interpolation, it is possible to convert the resolution without image degradation even when there is motion between images.

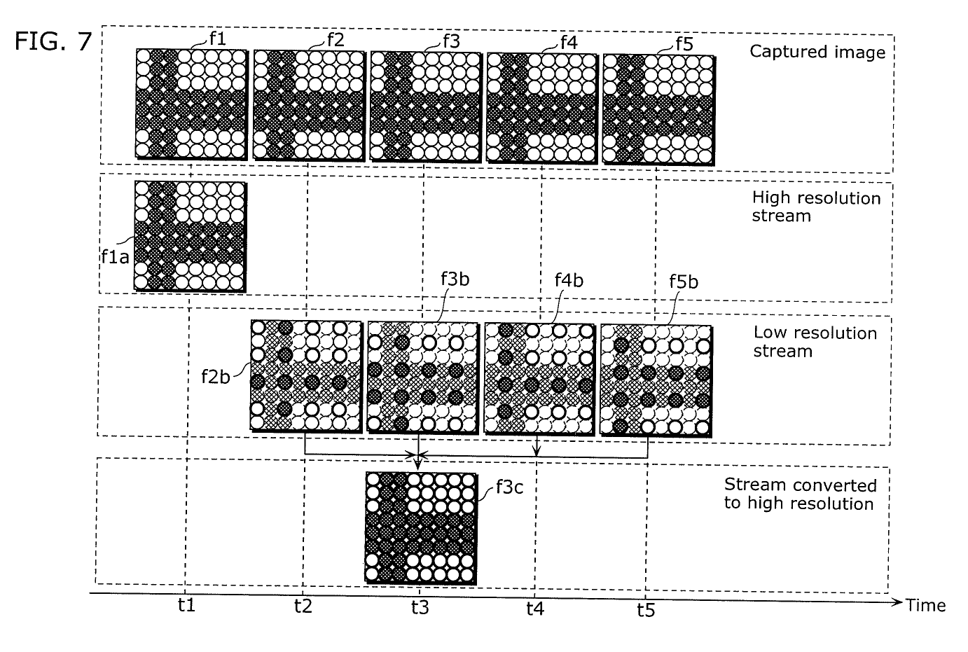

FIG. 7 is an illustrative diagram for describing an example of converting an image to high resolution by the resolution conversion unit 213.

The resolution conversion unit 213, for example, converts, using a low resolution image, another low resolution image to high resolution by interpolating a pixel into the other low resolution image.

Specifically, as shown in FIG. 7, the imaging unit 101 in the image recording device 100 according to the first embodiment generates captured images f1 to f5 with timing according to the high frame rate. In other words, the captured image f1 is generated at time t1, the captured image f2 is generated at time t2, and captured image f3 is generated at time t3.

In the high-speed image capturing performed by the image recording device 100, such captured images f1 to f5 are recorded on the recording medium as a high resolution stream including coded data for displaying the high resolution image f1a and a low resolution stream including coded data for displaying low resolution images f2b to f5b. In other words, the image f1a generated by decoding the high resolution stream is identical to the captured image f1, and the images f2b to f5b generated by decoding the low resolution stream are images obtained by decimating pixels from the captured images f2 to f5, respectively, such that the captured images f2 to f5 are vertically and horizontally reduced to half in size. Note that in each of the images f2b to f5b shown in FIG. 7, pixels thickly drawn with heavy lines are pixels included in the image and recorded on the recording medium, and thinly-drawn pixels are decimated pixels that are not recorded on the recording medium.

In addition, for the low resolution images f2b to f5b, pixels located at spatial positions different from each other are recorded. In other words, the pixel decimated from one of the low resolution images f2b to f5b is consistently included in another one of the images f2b to f5b that is other than the image from which the pixel is decimated.

Thus, for example, the resolution conversion unit 213 uses the low resolution images f2b, f4b, and f5b when converting the low resolution image f3b to high resolution. In other words, the resolution conversion unit 213 interpolates, per spatial position of each pixel decimated from the image f3b, a pixel included in one of the images having the pixel at the spatial position, into the spatial position of the decimated pixel on the image f3b. With this, the resolution conversion unit 213 converts the low resolution image f3b into the high resolution image f3c.

In high-speed image capturing, due to a short time interval between images, there is often no or small motion between images. Accordingly, by predicting the pixel at the position where the pixel is decimated from the low resolution image, using a pixel located at the same position in a preceding or succeeding image or a neighboring pixel, it is highly possible to perform interpolation without error. Thus, no significant degradation is caused in the images recorded at low resolution.

As described above, the image reproduction device 200 according to the second embodiment of the present invention can perform slow reproduction without significant image degradation by: decoding the high resolution stream recorded at the frame rate for normal image capturing and the low resolution stream recorded only in high-speed image capturing, further converting the low resolution images into images having the resolution of the images captured at the frame rate for normal image capturing, and outputting, in image capturing order, the images having the resolution converted and the images captured at the frame rate for normal image capturing.

Note that here all the images recorded only in high-speed image capturing are assumed to be recorded at resolution lower than the resolution of the image recorded at the frame rate for normal image capturing. However, even when part of the images are recorded at the same resolution (high resolution) as the images recorded at the frame rate for normal image capturing, it is possible to decode the part of the images by the image decoding unit 211.

In addition, the image decoding unit 211 and the low-resolution image decoding unit 212 may share all or part of the functions of each other.

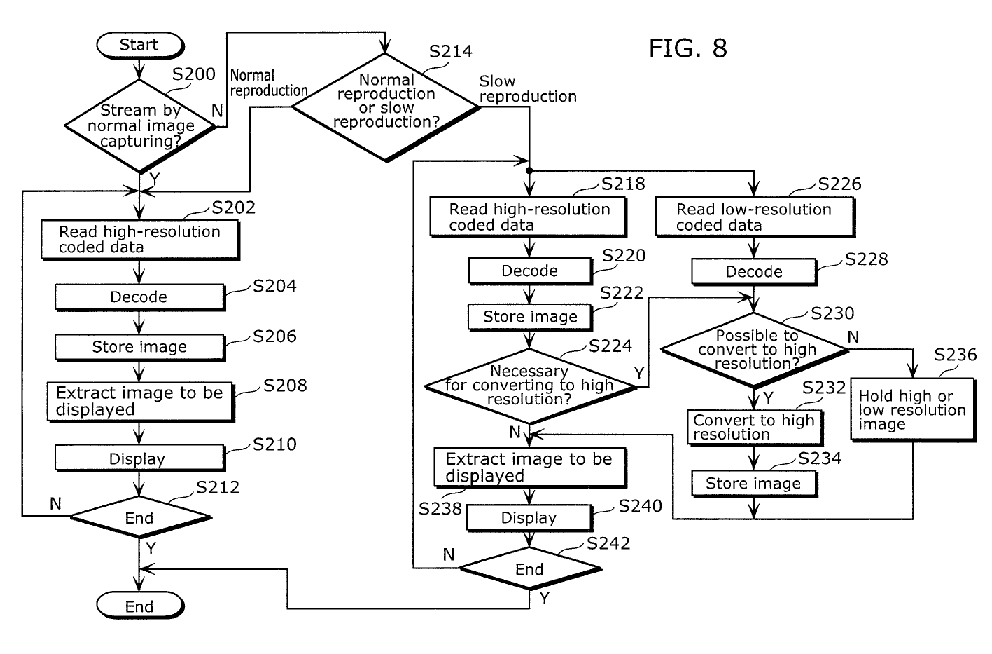

FIG. 8 is a flowchart showing an operation of the image recording device 200 in the present embodiment.

The image reproduction device 200 first determines whether or not a reproduction target designated by the reproduction operation unit 216 is a stream recorded by normal image capturing (Step S200). Here, when determining that the reproduction target is the stream recorded by normal image capturing (Y in Step S200), the image reproduction device 200 reads high resolution coded data included in the stream from the recording medium (Step S202). Subsequently, the image reproduction device 200 decodes the high resolution coded data (Step S204) and stores a high resolution image generated by the decoding into a buffer (for example, a buffer in the reproduction unit 214) (Step S206). Furthermore, the image reproduction device 200 extracts a high resolution image to be displayed from the buffer (Step S208) and displays the image (Step S210). Note that in Step S208, if the image to be displayed is not accumulated in the buffer, the processing in the steps S208 and S210 are omitted. Then, the image reproduction device 200 determines whether or not to terminate the reproduction, based on whether or not the displayed image is at the end of the stream (Step S212). Here, the image reproduction device 200 terminates the reproduction when determining that the reproduction is to be terminated (Y in Step S212), and repeats performing the processing from Step S202 when determining that the reproduction is not to be terminated (N in Step S212).

On the other hand, when determining that the reproduction target is a stream recorded by high-speed image capturing (N in Step S200), the image reproduction device 200 further determines whether to perform normal reproduction or to perform slow reproduction, based on the operation received by the reproduction operation unit 216 (Step S214). Here, when determining that normal reproduction is to be performed (Normal reproduction in Step S214), the image reproduction device 200 performs the processing from Step S202. In other words, the image reproduction device 200 sequentially reads and decodes coded data included in the high resolution stream among the streams (high resolution stream and low resolution stream) recorded by high-speed image capturing, and displays the decoded data.

In addition, when determining that slow reproduction is to be performed (Slow reproduction in Step S214), the image reproduction device 200 reads, in parallel, high-resolution coded data and low-resolution coded data from the high resolution stream and low resolution stream recorded by high-speed image capturing (Steps S218 and S226). The image reproduction device 200 decodes the high-resolution coded data that is read (Step S220), and stores a high resolution image generated by the decoding into the buffer (Step S222). Here, the image reproduction device 200 determines whether or not the high resolution image is necessary for converting a low resolution image to high resolution (Step S224).

When determining that the high resolution image generated by the decoding is necessary for the conversion to high resolution (Y in Step S224), the image reproduction device 200 further determines whether or not a low resolution image requiring the high resolution image has been generated, that is, whether or not it is possible to convert the low resolution image to high resolution (Step S230). When determining that it is possible to perform the conversion to high resolution (Y in Step S230), the image reproduction device 200 converts the low resolution image to high resolution, using the high resolution image generated in Step S220 (Step S232), and stores the image converted to high resolution, into the buffer (Step S234). In addition, when determining that it is not possible to convert the low resolution image to high resolution because the low resolution image requiring the high resolution images has not been generated yet (N in Step S230), the image reproduction device 200 temporarily stores the high resolution image (Step S236).

On the other hand, when determining that the high resolution image generated by the decoding is not necessary for converting the low resolution image to high resolution (N in Step S224), the image reproduction device 200 extracts a high resolution image to be displayed from the buffer (Step S238), and displays the high resolution image (Step S240). Note that in Step S238, if the image to be displayed is not accumulated in the buffer, the processing in the steps S238 and S240 is omitted.

In addition, the image reproduction device 200 generates a low resolution image by decoding low-resolution coded data read in Step S226 (Step S228). Then, the image reproduction device 200 determines whether or not a high resolution image necessary for converting the low resolution images to high resolution has already been generated and held, that is, whether or not it is possible to convert the low resolution image to high resolution (Step S230).

Here, when determining that it is possible to convert the low resolution image to high resolution (Y in Step S230), the image reproduction device 200 converts the low resolution image to high resolution using the high resolution image (Step S232), and stores, into the buffer, an image obtained by the conversion to high resolution (Step S234). On the other hand, when determining that it is not possible to convert the low resolution image to high resolution because the high resolution image has not been generated yet (N in Step S230), the image reproduction device 200 temporarily stores the low resolution image (Step S236). Furthermore, the image reproduction device 200 extracts a high resolution image to be displayed from the buffer (Step S238), and displays the image (Step S240). Note that in Step S238, if the image to be displayed is not accumulated in the buffer, the processing in the steps S238 and S240 is omitted.

Then, after Step S240, the image reproduction device 200 determines whether or not to terminate the reproduction, based on the operation received by the reproduction operation unit 216, or based on whether or not the displayed image has been located at the end of the stream recorded by high-speed image capturing (Step S242). Here, the image reproduction device 200 terminates the reproduction when determining that the reproduction is to be terminated (Y in Step S242), and repeats performing the processing from Step S218 to 226 when determining that the reproduction is not to be terminated (N in Step S242).

Note that in the operation of the image recording device 200 shown in FIG. 8, the reading of the coded data from the recording medium, the decoding, and the display have been performed in synchronization, but they need not be performed in synchronization. In other words, a cycle of reading the coded data from the recording medium, decoding the coded data, and storing the decoded data into the buffer and a cycle of extracting and displaying the image stored in the buffer may be different. In addition, in Step S232, the image reproduction device 200 has converted a low resolution image to high resolution using a high resolution image, but may also perform the conversion to high resolution using another low resolution image.

The image recording device 100 and the image reproduction device 200 according to an implementation of the present invention, which have been described using the first and second embodiments, are applicable, for example, to a video camera and a DVD player.

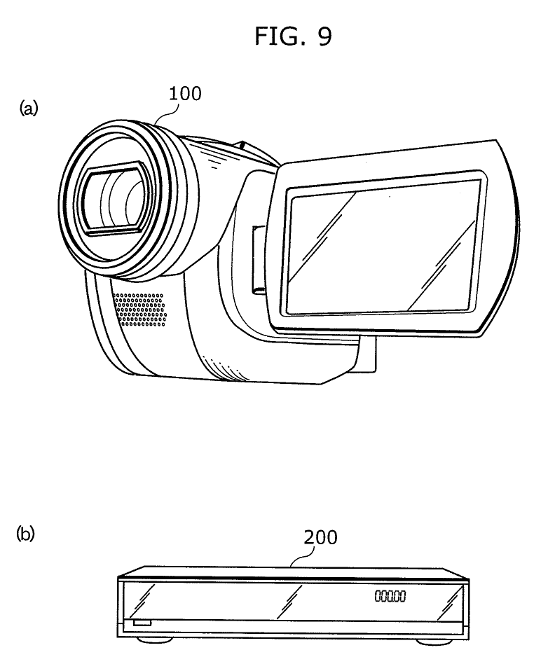

FIG. 9 is a diagram showing an example of an application of the image recording device 100 and the image reproduction device 200.

For example, as shown in FIG. 9(a), the image recording device 100 is configured as a video camera which records a captured image on a recording medium such as a DVD. In addition, as shown in FIG. 9(b), the image reproduction device 200 is configured as a DVD player which reads and reproduces the image recorded on the recording medium such as the DVD. Note that the video camera shown in FIG. 9(a) may include the image recording device 100 and the image reproduction device 200.

In addition, the image recording device and the image reproduction device according to an implementation of the present invention have been described using the first and the second embodiments, but the present invention is not limited to these embodiments.

For example, in the first embodiment, the image signal processing unit 102 has generated a low resolution image and has outputted the generated image to the low-resolution image coding unit 104 by reading remaining pixels except a part of the pixels, from the captured image generated by the imaging unit 101. However, the image signal processing unit 102 may generate a low resolution image by reading all the pixels making up the captured image generated by the imaging unit 101, and deleting (decimating) part of the pixels from all the pixels that are read.

In addition, in the second embodiment, the resolution conversion unit 213 has used only one of the high resolution image and another low resolution image when converting a low resolution image to high resolution, but both images may be used. In addition, the resolution conversion unit 213 has performed motion compensation on a high resolution image so as to convert a low resolution image to high resolution, but may also perform motion compensation on another low resolution image so as to convert the low resolution image to high resolution.

In addition, in the second embodiment, by converting the low resolution images to high resolution, the resolution conversion unit 213 has conformed the resolution of the images outputted from the low-resolution image decoding unit 212 to the resolution of the images outputted from the image decoding unit 211. However, the resolution conversion unit 213 may conform, reversely, the resolution of the images outputted from the image decoding unit 211 to the resolution of the images outputted from the low-resolution image decoding unit 212 by converting the high resolution images to low resolution. In this case, the reproduction unit 214 causes all the low resolution images to be displayed in image capturing order in a small region that is a part of the display or on another small display.

In addition, respective function blocks in a block diagram (FIGS. 1 and 5) in the first and the second embodiments are typically realized as an LSI that is an integrated circuit. These functions may be separately configured as a single chip, or may be configured as a single chip that includes part or all of these functions. The integrated circuit may be an IC, a system LSI, a super LSI, or an ultra LSI, depending on integration degree. In addition, the method for integration is not limited to the LSI, but may also be realized as a dedicated circuit or a general-purpose processor. After manufacturing the LSI, a field programmable gate array (FPGA) that allows programming or a reconfigurable processor for which connections of circuit cells and settings within the LSI are reconfigurable may be used. Furthermore, when another integrated circuit technology appears to replace the LSI as a result of development of the semiconductor technology or some derivative technique, these function blocks may naturally be integrated using the technology. In addition, among these functions, only units for storing the data to be coded or decoded may have a separate configuration instead of being included in the single chip.

### INDUSTRIAL APPLICABILITY

The image recording device and the image reproduction device according an implementation of the present invention are applicable to an image recording device and an image reproduction device which perform high-speed image capturing and reproduction of a capture image, and are particularly applicable to a video camera or the like which, where necessary, records an image captured at high speed and displays a smooth slow reproduction image when reproducing the captured image.

1. An image recording device which records an image on a recording medium, said image recording device comprising:
an image processing unit configured to sequentially read, at a second frame rate, images generated by an imaging unit, and to output, from among the images sequentially read, images read at a first frame rate at first resolution and other images at second resolution, the first frame rate being lower than the second frame rate, and the second resolution being lower than the first resolution;
a coding unit configured to generate a first coded stream by coding an image sequence made up of the images having the first resolution, and to generate a second coded stream by coding an image sequence made up of the other images having the second resolution, the images and the other images being outputted by said image processing unit, and the second coded stream being reproducible at the second frame rate when reproduced in combination with the first coded stream; and
a recording unit configured to record, on the recording medium, the first and the second coded streams generated by said coding unit.

2. The image recording device according to claim 1,
wherein said image processing unit is configured to generate the other images having the second resolution by reading only pixels that constitute a part of pixels making up the image generated by the imaging unit.

3. The image recording device according to claim 2,
wherein said image processing unit is configured to read, per line as a unit of reading, at least one remaining unit of reading which is other than at least one unit of reading among units of reading included in the image, the line being made up of horizontally-arranged pixels among the pixels making up the image.

4. The image recording device according to claim 2,
wherein said image processing unit is configured to read, per column as a unit of reading, at least one remaining unit of reading which is other than at least one unit of reading among units of reading included in the image, the column being made up of vertically-arranged pixels among the pixels making up the image.

5. The image recording device according to claim 2,
wherein said image processing unit is configured to specify, from among the pixels making up the image, lines each made up of horizontally-arranged pixels and columns each made up of vertically-arranged pixels, and to read a pixel located at an intersection of each of the specified lines and each of the specified columns.

6. The image recording device according to claim 2,
wherein, when reading the other images while sequentially reading two images at the first frame rate, said image processing unit is configured to read pixels each located at a spatial position that differs from one image to another among the other images.

7. The image recording device according to claim 1,
wherein said image processing unit is configured to output, at the first resolution, an image which is, among the images sequentially read at the second frame rate, other than the images read at the first frame rate and the other images.

8. The image recording device according to claim 1,
wherein said image processing unit is configured to read, at the first resolution, each of the images generated by the imaging unit, and to generate each of the other images having the second resolution by decimating pixels that constitute a part of pixels included in the read image.

9. The image recording device according to claim 1,
wherein said coding unit includes:
a first coding unit configured to code the image sequence made up of the images having the first resolution; and
a second coding unit configured to code the image sequence made up of the other images having the second resolution.

10. An image reproduction device which reads, from a recording medium, a coded stream of an image sequence made up of images captured at a predetermined frame rate, and reproduces the image sequence,
wherein a first coded stream and a second coded stream are recorded on the recording medium, the first coded stream including first images coded at first resolution, and the second coded stream including second images coded at second resolution lower than the first resolution,
said image reproduction device comprising:
a read mechanism unit configured to read the first and the second coded streams from the recording medium;
a decoding unit configured to decode the first images from the first coded stream, and to decode the second images from the second coded stream, the first and the second coded streams being read by said read mechanism unit;
a resolution conversion unit configured to convert a resolution of the second images decoded by said decoding unit to the first resolution; and
a reproduction unit configured to cause a display unit provided outside said image reproduction device to display the first and the second images in image capturing order, by processing, as a single video signal, a video signal indicating the first images decoded by said decoding unit and a video signal indicating the second images having the resolution converted to the first resolution.

11. The image reproduction device according to claim 10,
wherein said resolution conversion unit is further configured to convert a resolution of the first images decoded by said decoding unit to the second resolution, and
said reproduction unit is further configured to cause said display unit to display, in the image capturing order, the second images decoded by said decoding unit and the first images having the resolution converted to the second resolution.

12. The image reproduction device according to claim 10,
wherein said resolution conversion unit is configured to interpolate a pixel included in one of the first images that are decoded, into a same position as a spatial position of the pixel in one of the second images that are decoded, so as to convert the resolution of the one of the second images to the first resolution.

13. The image reproduction device according to claim 10,
wherein each of the second images coded and included in the second coded stream includes a pixel at a spatial position different from a spatial position of a pixel in another one of the second images, and
when assuming that one of the second images that are decoded and sequential in the image capturing order is to be converted, said resolution conversion unit is configured to convert the resolution of the one of the second images to the first resolution by interpolating a pixel included in another one of the second images that is other than the one of the second images that is to be converted, into a same position as the spatial position of the pixel in the one of the second images that is to be converted.

14. The image reproduction device according to claim 10,
wherein said resolution conversion unit is configured to estimate motion between one of the first images that are decoded and one of the second images that are decoded, to compensate the one of the first images with the estimated motion, and to interpolate a pixel included in the one of the first images that is compensated with the estimated motion, into a same position as the spatial position of the pixel in the one of the second images, so as to convert the resolution of the one of the second images to the first resolution.

15. The image reproduction device according to claim 10,
wherein said resolution conversion unit is configured to estimate motion between one of the second images that are decoded and another one of the second images, to compensate the one of the second images with the estimated motion, and to interpolate a pixel included in the one of the second images that is compensated with the estimated motion, into a same position as the spatial position of the pixel in the another one of the second images that is decoded, so as to convert a resolution of the another one of the second images to the first resolution.

16. The image reproduction device according to claim 10,
wherein said decoding unit includes:
a first decoding unit configured to decode the first images from the first coded stream; and
a second decoding unit configured to decode the second images from the second coded stream.

17. An image recording method for recording an image on a recording medium, said image recording method comprising:
sequentially reading, at a second frame rate, images generated by an imaging unit, and outputting, from among the images sequentially read, images read at a first frame rate at first resolution and other images at second resolution, the first frame rate being lower than the second frame rate, and the second resolution being lower than the first resolution;
generating a first coded stream by coding an image sequence made up of the images having the first resolution, and generating a second coded stream by coding an image sequence made up of the other images having the second resolution, the images and the other images being outputted in said sequentially reading, and the second coded stream being reproducible at the second frame rate when reproduced in combination with the first coded stream; and
recording, on the recording medium, the first and the second coded streams generated in said generating.

18. An image reproduction method for reading a coded stream of an image sequence made up of images captured at a predetermined frame rate and reproducing the image sequence,
wherein a first coded stream and a second coded stream are recorded on the recording medium, the first coded stream including first images coded at first resolution and the second coded stream including second images coded at second resolution lower than the first resolution,
said image reproduction device comprising:
reading the first and the second coded streams from the recording medium;
decoding the first images from the first coded stream, and decoding the second images from the second coded stream, the first and the second coded streams being read in said reading;
converting a resolution of the second images decoded in said decoding to the first resolution; and
displaying the first and the second images in image capturing order, by processing, as a single video signal, a video signal indicating the first images decoded in said decoding and a video signal indicating the second images having the resolution converted to the first resolution.

19. A program for recording an image on a recording medium, said program causing a computer to execute:
sequentially reading, at a second frame rate, images generated by an imaging unit, and outputting, from among the images sequentially read, images read at a first frame rate at first resolution and other images at second resolution, the first frame rate being lower than the second frame rate, and the second resolution being lower than the first resolution;
generating a first coded stream by coding an image sequence made up of the images having the first resolution, and generating a second coded stream by coding an image sequence made up of the other images having the second resolution, the images and the other images being outputted in the sequentially reading, and the second coded stream being reproducible at the second frame rate when reproduced in combination with the first coded stream; and
recording, on the recording medium, the first and the second coded streams generated in the generating.

20. A program for reading a coded stream of an image sequence made up of images captured at a predetermined frame rate and reproducing the image sequence,
wherein a first coded stream and a second coded stream are recorded on the recording medium, the first coded stream including first images coded at first resolution and the second coded stream including second images coded at second resolution lower than the first resolution,
said program causing a computer to execute:
causing a read mechanism unit to read the first and the second coded streams from the recording medium;
decoding the first images from the first coded stream, and decoding the second images from the second coded stream, the first and the second coded streams being read by the read mechanism unit;
converting a resolution of the second images decoded in the decoding to the first resolution; and
causing a display unit to display the first and the second images in image capturing order, by processing, as a single video signal, a video signal indicating the first images decoded in the decoding and a video signal indicating the second images having the resolution converted to the first resolution.
